(19) United States
(12) Patent Application Publication
(10) Pub. No.: US 2024/0135355 A1
(43) Pub. Date: Apr. 25, 2024

(54) DIGITAL TAG INCLUDING REQUEST FOR INTERACTION

(71) Applicant: VISA INTERNATIONAL SERVICE ASSOCIATION, San Francisco, CA (US)

(72) Inventors: Sonal Verma, Hayward, CA (US); Jarkko Oskari Sevanto, Berkeley, CA (US); Vikram Modi, Lafayette, CA (US); Micael de Torres Gomes, Alameda, CA (US)

(73) Assignee: VISA INTERNATIONAL SERVICE ASSOCIATION, San Francisco, CA (US)

(21) Appl. No.: 18/548,056

(22) PCT Filed: Sep. 1, 2021
(86) PCT No.: PCT/US2021/048920

§ 371 Date: Aug. 24, 2023

Related U.S. Application Data
(60) Provisional application No. 63/153,566, filed on Feb. 25, 2021.

(51) Int. Cl. G06Q 20/22

(52) U.S. Cl. CPC G06Q 20/223

(57) ABSTRACT

A method is disclosed. The method comprises receiving, by a digital tag computer from a receiver user device a transfer request comprising a digital tag associated with the receiver, a digital tag associated with a sender, and a transfer amount. The method then generates an identifier to be associated with the received transfer request. The digital tag computer then transmits the transfer request to a sender user device associated with the second user, where the transfer request includes the identifier associated with the request. After transmitting the transfer request, the digital tag computer receives a transfer message relating to the transfer request. Then, after receiving the transfer message, the digital tag computer transmits the transfer message.

### CROSS-REFERENCES TO RELATED APPLICATIONS

This application is a PCT application, which claims priority to and the benefit of U.S. Provisional Patent Application No. 63/153,566, filed Feb. 25, 2021, which is incorporated by reference in their entirety.

This case is also related to PCT/US2021/030145, filed on Apr. 30, 2021, which is herein incorporated by reference in its entirety.

### BACKGROUND

Peer-to-peer applications provide users of the application the ability to send, receive, or request payments from other users of the application. Many of such peer-to-peer applications identify users by aliases such as email addresses, phone numbers, usernames, or IDs. A first user can send, receive, or request a payment from second user using the alias of the second user. However, many peer-to-peer applications cannot provide all or some of their functionalities if the first user and the second user are not on the same peer-to-peer application. Aside from inter-operability concerns between different peer-to-peer applications, the use of different aliases complicates identifying users between the applications.

Embodiments of the disclosure address this problem and other problems individually and collectively.

### SUMMARY

One embodiment of the invention includes a method. The method comprising: receiving, by a digital tag computer from a receiver user device associated with receiver, a transfer request, wherein the transfer request comprises a digital tag associated with the receiver, a digital tag associated with a sender, and a transfer amount, wherein the digital tag associated with the receiver is linked to an account associated with the receiver and the digital tag associated with the sender is linked to an account associated with the sender; generating, by the digital tag computer, a request identifier to be associated with the received transfer request; transmitting, by the digital tag computer to a sender user device associated with the sender, the transfer request, wherein the transfer request further comprises the request identifier associated with the transfer request; responsive to transmitting the transfer request, receiving, by the digital tag computer, a transfer message relating to the transfer request; and responsive to receiving the transfer message, transmitting, by the digital tag computer, the transfer message.

Another embodiment includes a digital tag computer comprising: a processor and a computer readable medium comprising instructions executable by the processor to perform a method including: receiving, by a digital tag computer from a receiver user device associated with receiver, a transfer request, wherein the transfer request comprises a digital tag associated with the receiver, a digital tag associated with a sender, and a transfer amount, wherein the digital tag associated with the receiver is linked to an account associated with the receiver and the digital tag associated with the sender is linked to an account associated with the sender; generating, by the digital tag computer, a request identifier to be associated with the received transfer request; transmitting, by the digital tag computer to a sender user device associated with the sender, the transfer request, wherein the transfer request further comprises the request identifier associated with the transfer request; responsive to transmitting the transfer request, receiving, by the digital tag computer, a transfer message relating to the transfer request; and responsive to receiving the transfer message, transmitting, by the digital tag computer, the transfer message.

Yet another embodiment includes a method. The method comprising: generating, by a receiver user device, a transfer request message comprising a digital tag associated with a receiver, a digital tag associated with the sender, and a transfer amount, wherein the digital tag associated with the receiver is linked to an account associated with the receiver and the digital tag associated with the sender is linked to an account associated with the sender; transmitting, by the receiver user device to a digital tag computer, the transfer request message; and receiving, by the receiver user device or an first transfer application server from the digital tag computer, a transfer message comprising the transfer amount, wherein the transfer message was generated by a sender user device, wherein the account of the receiver is credited with the transfer amount.

A better understanding of the nature and advantages of embodiments of the present invention may be gained with reference to the following detailed description and accompanying drawings.

### BRIEF DESCRIPTION OF THE DRAWINGS

FIG. 1 shows a system and an example flow for a user requesting issuance of a digital tag from an authorizing entity according to embodiments.

FIG. 2 shows a system and an example flow for a user requesting issuance of a digital tag from a transfer application according to embodiments.

FIGS. 3A-3B show a system and an example flow for a receiver requesting payment from a sender according to embodiments.

FIG. 4 shows a block diagram illustrating a processing system according to embodiments.

FIG. 5 shows a block diagram of a user device according to embodiments.

FIG. 6 shows a block diagram of a digital tag computer according to embodiments.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be any suitable device that a user can interact with (e.g., a payment card or mobile phone). User devices may be in any suitable form. Some examples of user devices include cellular phones, PDAs, personal computers (PCs), tablet computers, and the like. In some embodiments, where a user device is a mobile device, the mobile device may include a display, a memory, a processor, a computer-readable medium, and any other suitable component.

A “mobile device” (sometimes referred to as a mobile communication device) may comprise any suitable electronic device that may be transported and operated by a user, which may also provide remote communication capabilities to a network. A mobile communication device may communicate using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile device may comprise any suitable hardware and software for performing such functions, and may also include multiple devices or components (e.g., when a device has remote access to a network by tethering to another device—i.e. using the other device as a modem—both devices taken together may be considered a single mobile device).

A “digital wallet” can include an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card. A digital wallet may be a transfer application.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, and verification values such as CVV, dCVV, CVV2, dCVV2, and CVC3 values.

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN). For example, a payment token may include a series of alphanumeric characters that may be used as a substitute for an original account identifier. For example, a token “4900 0000 0000 0001” may be used in place of a PAN “4147 0900 0000 1234.” In some embodiments, a payment token may be “format preserving” and may have a numeric format that conforms to the account identifiers used in existing transaction processing networks (e.g., ISO 8583 financial transaction message format). In some embodiments, a payment token may be used in place of a PAN to initiate, authorize, settle or resolve a payment transaction or represent the original credential in other systems where the original credential would typically be provided. In some embodiments, a payment token may be generated such that the recovery of the original PAN or other account identifier from the token value may not be computationally derived. Further, in some embodiments, the token format may be configured to allow the entity receiving the token to identify it as a token and recognize the entity that issued the token.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the consumer.

A “digital tag” may be a unique identifier used to facilitate transfers. A digital tag may be a set of alphanumeric characters to be associated with a user. In some embodiments, the digital tag may be linked to a real credential. In some embodiments, the digital tag may be a payment tag that points to a virtual credential issued by an authorizing entity or other entity, and that is linked to an account registered with a peer-to-peer application. The virtual credential may be in the form of a real payment credential, but unlike a real payment credential, it cannot be used to independently conduct payment transactions.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

In embodiments of the invention, a transfer application (e.g., a peer-to-peer application), accessed (e.g., installed, accessed via a web browser, etc.) by a user operating a user device, may allow users of the application to send, receive, or request transfers from other users of the application. For example, a first user may use a transfer application on their user device to generate a transfer request (e.g., a request receive $20 USD from a second user, a request for data from a second user, etc.). The transfer request may comprise a transfer amount, and an alias associated with a second user. The alias may be a digital tag, which uniquely identifies the second user across different transfer applications (e.g., different wallet applications) via a digital tag computer. In some embodiments, the digital tag may be a payment tag and the digital tag computer may be a payment tag service computer. The digital tag may be issued by an authorizing entity and registered with the digital tag computer to be used in transfers.

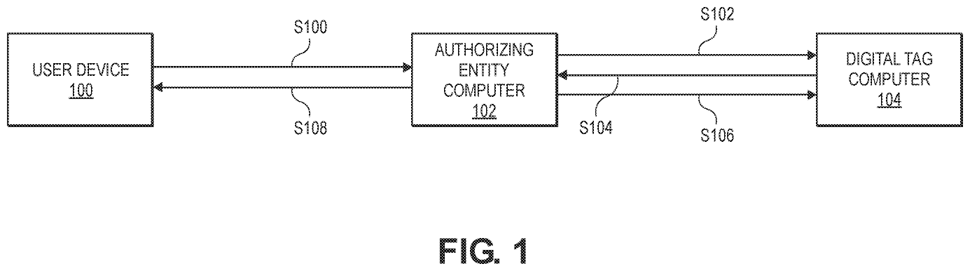

FIG. 1 shows an example flow for a user requesting issuance of a digital tag from an authorizing entity associated with an authorizing entity computer 102. The user may operate a user device 100. In some embodiments, the user device 100 may be a mobile phone, and the user may be a resource provider or an individual. The authorizing entity may be an issuer that holds an account (e.g., a credit or debit card account) of the user. The system illustrated in FIG. 1 comprises a user device 100, an authorizing entity computer 102, and a digital tag computer 104.

The components in the system of FIG. 1 and any of the following figures can be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); and Secure Hypertext Transfer Protocol (HTTPS).

In step S100, the user device 100 may generate a request for a digital tag. The request may include a set of alphanumeric characters to be used as the digital tag, and information related to the user operating the user device 100 (e.g., an email address associated with the user, a phone number associated with the user, etc.). The request for a digital tag may then be transmitted to an authorizing entity computer 102 associated with the user. The authorizing entity computer 102 may maintain an account associated with the user which may be indicated by a primary account number.

In step S102, after receiving the request for a digital tag from the user device 100, the authorizing entity computer 102 may verify the uniqueness of the requested digital tag. The authorizing entity computer 102 may transmit the request for the digital tag to the digital tag computer 104, which stores previously received requests (e.g., the digital tag computer 104 may maintain and search a digital tag database of digital tags to ensure that the requested digital tag does overlap with plurality of digital tags stored in the database). Although one authorizing entity computer 102 is shown as being in communication with the digital tag computer 104, there may be many authorizing entity computers in communication with the digital tag computer 104.

In step S104, after the digital tag computer 104 has searched the digital tag database to determine that the requested digital tag is not already assigned to another user, the authorizing entity computer 102 can receive a message from the digital tag computer 104 verifying the uniqueness of the digital tag. Then, the authorizing entity computer 102 may issue the digital tag to the user associated with the user device 100 by linking the digital tag to the primary account number of the user's account (e.g., the number which identifies the user's account managed by the authorizing entity). In some embodiments, the digital tag may be linked to an alternative account identifier such as a payment token.

In step S106, the issued digital tag and primary account number, or alternative account identifier, may be transmitted by the authorizing entity computer 102 to the digital tag computer 104 to be stored in the digital tag database. The issued digital tag may be in any suitable format. For example, the issued digital tag may be a payment token, a data string comprising a username and authorizing entity identifier, a phone number, an email address, a label (e.g., QR code), etc.

In step S108, the authorizing entity computer 102 may transmit the issued digital tag to the user device 100. After the user device 100 receives the issued digital tag, it may now be used in transfer applications to identify the user operating the user device 100.

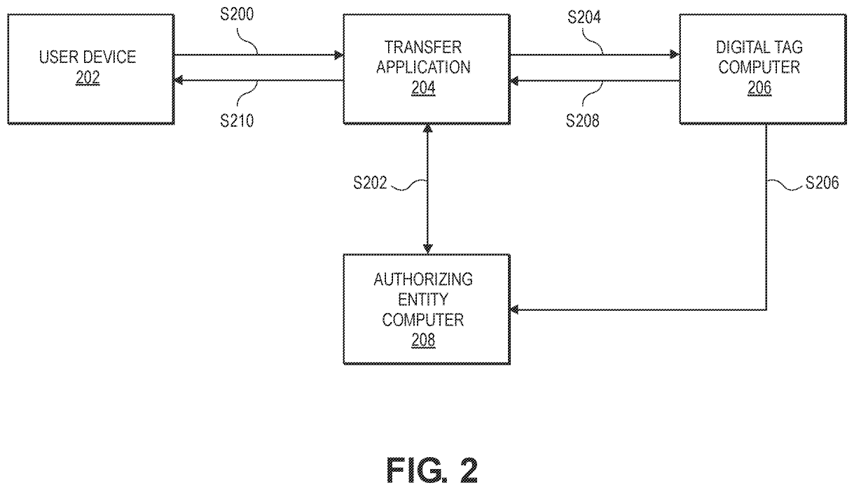

FIG. 2 shows an example flow for a user requesting issuance of a digital tag using a transfer application. The digital tag of FIG. 2 may be linked to a virtual credential. The digital tag linked to a virtual credential may be used in a peer-to-peer transactions, but unlike a real payment credential, it cannot be used to independently conduct payment transactions.

In step S200, a user device 202 may request a digital tag from a transfer application 204. The transfer application may be installed on the user device 202, and may have an application server (not shown) associated with it. For example, the transfer application may be a digital wallet application, and the application server may be a digital wallet server computer. The request may include a set of alphanumeric characters to be used as the digital tag, and information related to the user operating the user device 202 (e.g., an email address associated with the user, a phone number associated with the user, etc.).

In step S202, upon receiving the request for the digital tag, the transfer application 204 may issue a virtual credential via an associated authorizing entity computer 208. The authorizing entity computer 208 may create and return the virtual credential to the transfer application 204. In some embodiments, the virtual credential may be in the form of a real payment credential, but unlike a real payment credential, it cannot be used to independently conduct payment transactions. The credential that will be issued can be a virtual receive only credential (i.e. a credential that only support incoming payments), or the credential can be a fully functional payment credential (e.g. a PAN) that can also be used for purchases, AFTs etc.

In step S204, the transfer application 204 may submit a request to a digital tag computer 206 to create a digital tag associated with the user. The request may comprise the digital tag chosen by the user in step S200, and the virtual credential issued by the authorizing entity computer 208 in step S202.

In step S206, the digital tag computer 206 may receive the request to create a digital tag. The digital tag computer 206 may retrieve the digital tag and the virtual credential from the request. Upon verifying the uniqueness of the digital tag from a database storing previously received requests (e.g., searching a database of digital tags to ensure that the requested digital tag does overlap with plurality of digital tags stored), the digital tag computer 206 may tokenize the virtual credential. After tokenizing the virtual credential, the digital tag computer 206 may store the digital tag, the tokenized virtual credential, and the virtual credential and approve use of the digital tag by notifying the authorizing entity computer 208.

In some embodiments, the virtual credential can be a receive only credential. This can be used to add a layer of security when the token is used by a payment originator to initiate an OCT message. If the token is compromised by a third-party, the third-party will be unable to pull funds from the underlying account.

In step S208, the digital tag computer 206 may confirm the approval of the digital tag with the transfer application 204.

In step S210, the transfer application 204 may notify the user device 202 the digital tag was approved and is available for use. The virtual credential linked to the digital tag may point to an account managed by the transfer application 204.

The digital tags of FIGS. 1 and 2 may be used in a peer-to-peer transfer. For example, a first user using a first transfer application may send, receive, or request a transaction with a second user using a second transfer application. The digital tag allows for the transaction to be initiated with the digital tag of the second user which will then be resolved into a credential, or virtual credential, that links to an account managed by the transfer application of the second user.

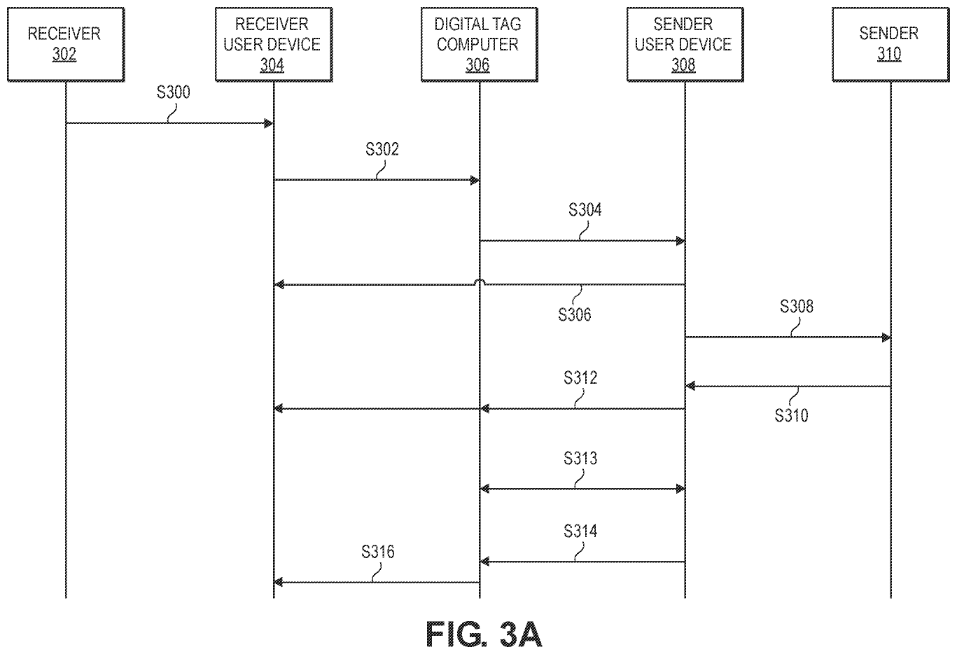

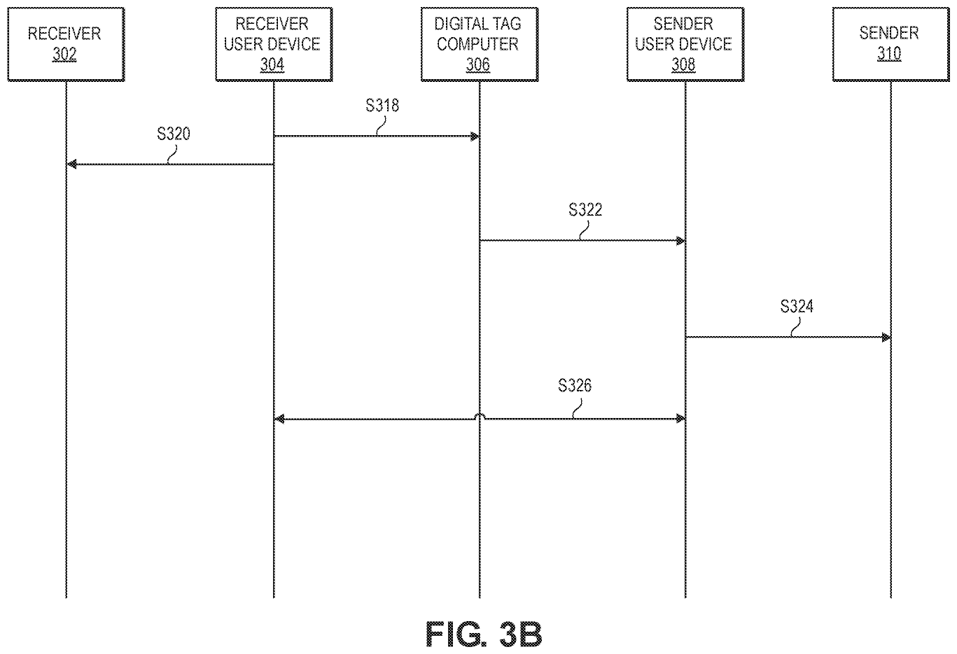

FIGS. 3A and 3B show a system and an overlying method according to embodiments of the invention. FIGS. 3A and 3B show a receiver user device 304 operated by a receiver 302, and a sender user device 308 operated by a sender 310. The sender 310 may be a first user that sends funds to the receiver 302 which may be a second user. The receiver user device 304 and the sender user device 308 may be in operative communication with a digital tag computer 306. The digital tag computer 306 may be similar to the previously described digital tag computer 104.

The receiver user device 304 may have a first transfer application and the sender user device 308 may have a second transfer application. The first transfer application may be a first digital wallet application and the second transfer application may be a second digital wallet application, where the first digital wallet application and the second digital wallet application are operated by different entities (e.g., different companies). The first transfer application and the second transfer application may be operated by different entities such that the transfer of funds between the two transfer applications is not normally possible. The second transfer application on the sender user device 308 may be linked to or in communication with a second financial institution computer (e.g., an acquirer computer or an issuer computer), while the first transfer application on the receiver user device 308 may be linked to or in communication with a first financial institution computer (e.g., an acquirer computer or an issuer computer). The second financial institution computer may hold an account (e.g., a credit or debit card account) associated with the sender 310, while the first financial institution computer may hold an account associated with the receiver 302. A payment processing network may be present between the first financial institution computer and the second financial institution computer and can route push transaction messages and other transaction messages between various financial institution computers including the first and second financial institution computers.

The devices and computers in the system of FIGS. 3A-3B, and the financial institution computers and payment processing network described above can be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); and Secure Hypertext Transfer Protocol (HTTPS).

FIGS. 3A and 3B show a flow for a receiver 302 requesting a transfer of funds from a sender 310. The receiver 302 may be a first user and the sender 310 may be a second user. The system includes a receiver user device 304 operated by the receiver 304, which may access a first transfer application and a sender user device 308 operated by the sender 310, which may access a second transfer application. The transfer applications may be present on the receiver and sender user devices, which may be communication devices such as mobile phones. A digital tag computer 306 may route communications between the receiver user device 304 and the sender user device 308. The digital tag computer 306 may be in the form of a server computer.

In step S300, a receiver 302 may provide a transfer request to a receiver user device 304. The transfer request may be a payment request and comprise a transfer amount (e.g., an amount of funds such as $20 USD) that is requested from a sender 310, and a sender digital tag (e.g., a payment tag associated with the sender 310). The sender digital tag may be known by the receiver 302 from communication occurring prior to the method of FIG. 3. Some examples include, the receiver device 304 may have previously received the sender digital tag from the sender user device 308, the receiver 302 may have previously received the sender digital tag verbally from the sender 310, the receiver 302 may use the receiver user device 304 to scan a QR code provided by the sender device 312 to receive the sender digital tag (potentially through a prior transfer request), through e-mail, short message service, etc.

In step S302, the receiver user device 304 may generate the transfer request and forward the transfer request to a digital tag computer 306. The receiver user device 304 may further include a receiver tag (e.g., a digital tag associated with the receiver 302) in the transfer request. In some embodiments, the receiver user device 304 may communicate with a server computer associated with the transfer application. For example, the receiver user device 304 may communicate with a first transfer application server to generate the transfer request and transmit the transfer request to the digital tag computer 306. In some embodiments, the first transfer application server could be the first financial institution computer described above. The sender user device 308 may have a second transfer application, which may allow the sender user device 308 to communicate with a second transfer application server. In some embodiments, the second transfer application server could be the second financial institution computer described above.

In step S304, after receiving the transfer request from the first transfer application server associated with the first transfer application on the receiver user device 304, the digital tag computer 306 may then route the transfer request to a sender user device 308, or the second transfer application server associated with the second transfer application on the sender user device 308. In some embodiments, the digital tag computer 306 may retrieve the location or the address (e.g., a phone number, IP address, etc.) of the sender user device 308 using the received sender digital tag. The sender digital tag may contain the location or address of the sender user device 308 (or the second transfer application or its corresponding second transfer application server), or the location or the address of the sender user device 308 may be stored in a database (in communication with the digital tag computer 306) and may be mapped to the sender digital tag. The digital tag computer 306 may additionally include a request identifier in the transfer request. The request identifier may include any suitable number of characters and may be in any suitable form including a random string of letters and numbers. The digital tag computer 306 may further include information related to the receiver 302 (e.g., the receiver payment tag, the receiver name, a phone number associated with the receiver, an email associated with the receiver etc.) in the transfer request. The information may have been stored from a previous request or previously received from the receiver user device 304.

In step S306, the sender user device 308 may confirm receipt of the transfer request to the receiver 302 via the receiver user device 304. In some embodiments, the sender user device 308 may communicate directly with the receiver user device 304, or via the digital tag computer 306. The confirmation message informs the receiver 302 that the request for transfer was successfully received by the sender.

In step S308, the sender user device 308 may then display an approval request message related to the transfer request to the sender 310. For example, the approval request may display the transfer amount requested, and information related to the receiver 302 (e.g., the receiver tag, the receiver name, contact information associated with the receiver, etc.).

In step S310, at any point after receiving the approval request, the sender 310 may respond to the approval request (e.g., approve or deny) on the sender user device 308. Approval of the transfer request may comprise a process such as tapping a “CONFIRM” button displayed on the sender user device 308 (e.g., on the second transfer application on the sender user device 308). The sender 310 may also adjust the transfer amount (e.g., increase the transfer amount, or decrease the transfer amount) before responding to the approval request.

In step S312, upon approval from the sender 310, the sender user device 308 may forward the approval to proceed with the transfer request associated with the request identifier to the digital tag computer 306. In some embodiments, the digital tag computer 306 may further forward the approval to the receiver user device 304 which may display the approval by the sender 310 of the transfer request to the receiver 302.

In step S313, the second transfer application on the sender user device 308 can resolve the receiver digital tag with the digital tag computer 306. The sender user device 308 can send the receiver digital tag to the digital tag computer 306, and the digital tag computer 306 may return the receiver's account number or token that is associated with the receiver digital tag. In some embodiments, the digital tag computer 306 may return the previously described virtual credential.

In other embodiments, the receiver's account number or token may be determined by the digital tag computer 306 after the sender user device 308 sends the transfer message to the digital tag computer 306.

In step S314, the sender user device 308 may then initiate the sending of a transfer message such as a push transfer instruction message. In some embodiments, the transfer message may be an original credit transaction (OCT) transfer message and may comprise at least the digital tag associated with the receiver, the previously described virtual credential, the primary account number associated with the receiver or the token of the primary account number, and the transfer amount. An OCT (Original Credit Transaction) can be a clearing and settlement credit transaction designed for use in business applications such as a business money transfer or business-to-consumer repayments. The OCT can be a transaction used to deliver funds to the receiver account. It is separate from, and can take place after, an AFT transaction in some cases. This timing is to ensure that payment funds are secured before funds are sent to the receiver. As noted above, before originating the OCT transfer message, the second transfer application on the sender user device 308 may first request (e.g., via an API) that the receiver tag be resolved by the digital tag computer 306 so that the actual account number or token of the account number is obtained by the second transfer application of the sender user device 308. The second transfer application of the sender user device 308 may then generate transmit the OCT transfer message to the digital tag computer 306 or a payment processing network associated with the digital tag computer 306.

More specifically, in some embodiments, in step S314, the second application on the sender user device 308 can generate the transfer message (e.g., an OCT message) using the second transfer application, and the transfer message can be passed to the second transfer application server (not shown) associated with the second transfer application. The second transfer application server can then transmit the transfer message to the digital tag computer 306 or a payment processing network (not shown). The digital tag computer 306 may be part of the payment processing network, or may be independent of it.

The payment processing network may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

In step S316, the digital tag computer 306 (or the payment processing network) may route the transfer message (e.g., the OCT transfer message) to the first transfer application server computer associated with the first transaction application on the receiver user device 304. The receiver's account number or token may be used to route the transfer message to the first transfer application server computer associated with the first transfer application on the receiver user device 304. If the token is present, the digital tag computer 306 or a payment processing network associated with it, may obtain the receiver's primary account number from a token vault using the token. If the virtual credential is present, then it may be resolved into the token or the primary account number of the receiver before proceeding.

In step S318, after receiving the OCT transfer message, the first transfer application server associated with the first transfer application on the receiver user device 304 may then authorize the OCT transfer message, and can credit the receiver's account. The first transfer application server can make the transfer amount (e.g., the $20 USD) requested by the transfer available in the account linked to the digital tag of the receiver. The first transfer application server associated with the first transfer application receiver user device 304 may then generate an OCT response message and transmit the OCT response message to the digital tag computer 306 or a payment processing network associated with the digital tag computer 306.

In step S320, the receiver user device 304 may display confirmation of the transfer to the receiver 302. For example, it may display the sender digital tag and the transfer amount, along with a confirmation message that the transfer amount is now available in the account linked to the receiver digital tag.

In step S322, after receiving the OCT response message from the receiver user device 304, the digital tag computer 306 may route the OCT response message to the second transfer application server associated with the second transfer application on the sender user device 308. The second transfer application server can then provide a notification of the response to the second transfer application on the second user device 308.

In step S324, after receiving the OCT response message from the digital tag computer 306, the sender user device 308 may notify the sender 310 of the completion of the transfer amount to the account linked to the receiver digital tag.

In step S326, in a payment request, a settlement of funds between the first transfer application server (e.g., a first financial institution computer such as a first issuer) associated with the first transfer application on the receiver user device 304 (e.g., the authorizing entity 102 of FIG. 1 which issued the receiver digital tag) and a second transfer application server (e.g., a second financial institution computer such as a second issuer) associated with a second transfer application on the sender user device 308 may occur.

Further details on the OCT transfer (step S314 through step S322) can be found in U.S. Pat. Nos. 8,851,366 and 10,402,815, which are incorporated by reference in their entirety.

Methods described with respect to FIG. 3 have a number of advantages. The method of FIG. 3 allows the receiver 302 to request a transfer amount from the sender 310 using a transfer application of their choice accessed on the receiver user device 304. The receiver 302 does not need to know the transfer application that the sender 310 uses, only generating the transfer request using the sender digital tag. In a payment request, the receiver 302 can request access to funds from the sender 310, simply using the sender digital tag. In traditional methods, the receiver 302 and the sender 310 would need to use the same transfer application system and that is not needed in embodiments of the invention. Further, the digital tags according to embodiments can help protect the actual account numbers of senders and receivers from being exposed unnecessarily.

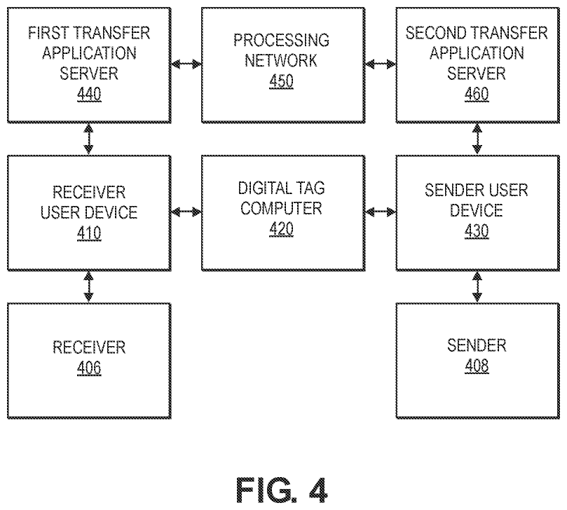

FIG. 4 shows a block diagram illustrating a more detailed architecture of a processing system according to an embodiment. FIG. 4 shows a receiver user device 410 and a sender user device 430 communicating with a digital tag computer 420. A first transfer application on the receiver user device 410 can be associated with a first transfer application server 440. A second transfer application on the sender user device 430 can be in communication with a second transfer application server 460. The first transfer application server 440 and the second transfer application server 460 can communicate with each other via the processing network 450. The first transfer application server 440 may hold an account of the receiver 406. The second transfer application server 460 can hold an account of the sender 408. Although the processing network 460 and the digital tag computer 420 are shown as separate entities, they may be embodied by the same entity in some embodiments.

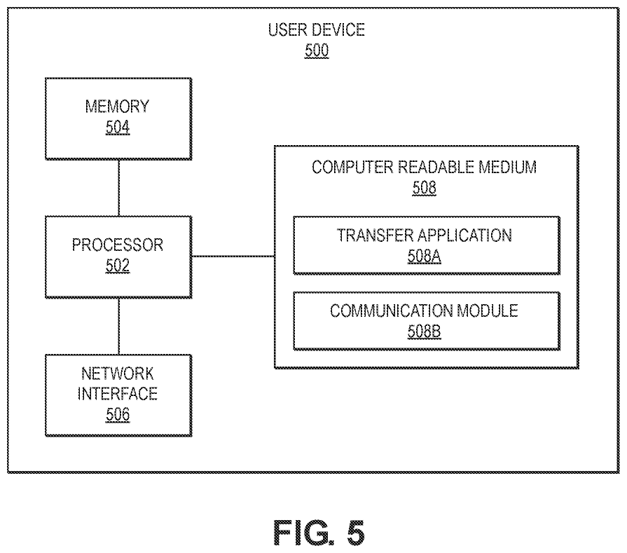

FIG. 5 shows a block diagram of a user device 500 according to embodiments. The user device 500 may be operated by, for example, the receiver of FIG. 3. In some embodiments, the user device 500 may access a transfer application to facilitate transfer between a user and another party (e.g., the payment transfer between the receiver 302 and the sender 310 of FIG. 3). The user device 500 may comprise a processor 502. The processor 502 may be coupled to a memory 504, a network interface 506, and a computer readable medium 508. The computer readable medium 508 may comprise any suitable number and types of software modules.

The memory 504 may be used to store data and code. The memory 504 may be coupled to the processor 502 internally or externally (e.g., via cloud based data storage), and may comprise any combination of volatile and/or non-volatile memory such as RAM, DRAM, ROM, flash, or any other suitable memory device. In some embodiments, the memory 504 may store the data items of a payload.

The network interface 506 may include an interface that can allow the user device 500 to communicate with external computers. The network interface 506 may enable the user device 500 to communicate data to and from another device such as a digital tag computer, an authorizing entity computer, etc. Some examples of the network interface 506 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 506 may include Wi-Fi™. Data transferred via the network interface 506 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 506 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 508 may comprise code, executable by the processor 502, for a method comprising: generating, by a receiver user device, a transfer request message comprising a digital tag associated with a receiver, a digital tag associated with the sender, and a transfer amount, wherein the digital tag associated with the receiver is linked to an account associated with the receiver and the digital tag associated with the sender is linked to an account associated with the sender; transmitting, by the receiver user device to a digital tag computer, the transfer request message; and receiving, by the receiver user device or an first transfer application server from the digital tag computer, a transfer message comprising the transfer amount, wherein the transfer message was generated by a sender user device, wherein the account of the receiver is credited with the transfer amount.

The computer readable medium 508 may comprise a number of software modules including, but not limited to, a transfer application 508A, and a communication module 508B.

The transfer application 508A may comprise code that causes the processor 502 to generate and receive transfer requests. For example, the transfer application 508A may be used to perform the transfer requests in the method of FIG. 3. The transfer application 508A may generate OCT transfer messages and OCT response messages.

The communication module 508B may comprise code that causes the processor 502 to generate messages, forward messages, receive message, reformat messages, and/or otherwise communicate with other entities. In some embodiments, the communication module 508B may facilitate transfer messages being transmitted to a digital tag computer, or requests for digital tag issuance.

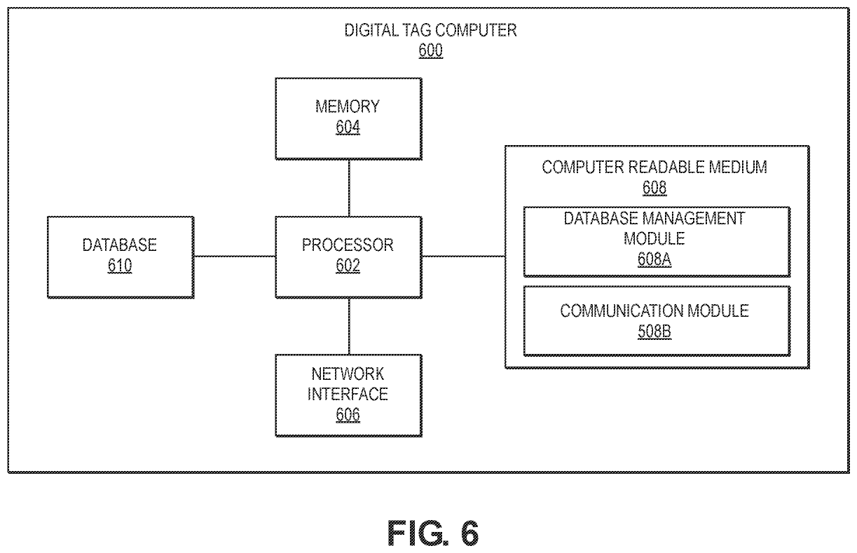

FIG. 6 shows a block diagram of a digital tag computer 600 according to embodiments. The digital tag computer 600 may facilitate the use of a digital tag. For example, the digital tag computer 600 may resolve a digital tag to an account identifier that was linked during issuance of the digital tag. The digital tag computer 600 may store a plurality of digital tags in memory. The digital tag computer 600 may comprise a processor 602. The processor 602 may be coupled to a memory 604, a network interface 606, a computer readable medium 608, and a database 610. The computer readable medium 608 may comprise any suitable number and types of software modules.

The memory 604 can be used to store data and code. In some embodiments, the memory 604 may be linked to a database 610. The memory 604 and/or the database 610 may be coupled to the processor 602 internally or externally (e.g., via cloud based data storage), and may comprise any combination of volatile and/or non-volatile memory such as RAM, DRAM, ROM, flash, or any other suitable memory device. The database 610 may comprise a directory for the link between a digital tag and an account identifier. In some embodiments, the digital tag computer 600 may store the data items (e.g., a digital tag, the account identifier and/or tokenized digital tag, etc.) received as a result of issuing a digital tag in the database 610 (e.g., the issuing processes described in FIGS. 1 and 2).

The network interface 606 may include an interface that can allow the digital tag computer 600 to communicate with external computers. The network interface 606 may have the same features or different features as the previously described network interface 506.

The computer readable medium 608 may comprise code, executable by the processor 602, for a method comprising: receiving, from a receiver user device associated with receiver, a transfer request, wherein the transfer request comprises a digital tag associated with the receiver, a digital tag associated with a sender, and a transfer amount, wherein the digital tag associated with the receiver is linked to an account associated with the receiver and the digital tag associated with the sender is linked to an account associated with the sender; generating a request identifier to be associated with the received transfer request; transmitting, to a sender user device associated with the sender, the transfer request, wherein the transfer request further comprises the request identifier associated with the transfer request; responsive to transmitting the transfer request, receiving, from the second user device, a transfer message relating to the transfer request; and responsive to receiving the transfer message, transmitting the transfer message.

The computer readable medium 608 may comprise a number of software modules including, but not limited to, a database management module 608A, and a communication module 608B.

The database management module 608A may comprise code that causes the processor 602 to manage data stored by the memory 602 and/or the database 610. For example, during issuance of a digital tag (e.g., the processes shown by FIGS. 1 and 2) the database management module 608A may allow the processor 602 to verify the uniqueness of a received digital tag to a plurality of digital tags stored in the memory 602 or the database 610. In some embodiments, after the digital tag computer 600 receives an issued digital tag, the database management module 608A may retrieve the account identifier or token linked to the issued digital tag.

The communication module 608B may comprise code that causes the processor 602 to generate messages, forward messages, receive message, reformat messages, and/or otherwise communicate with other entities. For example, the communication module 608B may allow the processor 602 to receive a requests to issue a digital tag and to check the uniqueness of a digital tag from an authorizing entity computer and generate a response. The communication module 608B may be used to route communications to and from user devices.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a digital tag computer from a receiver user device associated with receiver, a transfer request, wherein the transfer request comprises a digital tag associated with the receiver, a digital tag associated with a sender, and a transfer amount, wherein the digital tag associated with the receiver is linked to an account associated with the receiver and the digital tag associated with the sender is linked to an account associated with the sender;
generating, by the digital tag computer, a request identifier to be associated with the received transfer request;
transmitting, by the digital tag computer to a sender user device associated with the sender, the transfer request, wherein the transfer request further comprises the request identifier associated with the transfer request;
responsive to transmitting the transfer request, receiving, by the digital tag computer, a transfer message relating to the transfer request; and
responsive to receiving the transfer message, transmitting, by the digital tag computer, the transfer message.

2. The method of claim 1 further comprising:
receiving, by the digital tag computer, a request to resolve the digital tag associated with the receiver to an account number or token of the receiver.

3. The method of claim 1, wherein the receiver user device communicates with the digital tag computer via a first transfer application server and the sender user device communicates with the digital tag computer via a second transfer application server and wherein the first transfer application server and the second transfer application server are not the same.

4. The method of claim 1, wherein the transfer request comprises an account number or token of the receiver.

5. The method of claim 1, wherein the transfer message is an OCT message.

6. The method of claim 5, further comprising:
performing, by the digital tag computer, a settlement process between a first transfer application server associated with the receiver user device and a second transfer application server associated with the sender user device.

7. The method of claim 1, wherein the receiver user device is a mobile device.

8. The method of claim 1, wherein the digital tag computer is in a processing network.

9. The method of claim 1, wherein the digital tag associated with the sender is in the form of a machine readable code.

10. The method of claim 1, wherein the digital tag computer comprises a server computer.

11. The method of claim 1, wherein the transfer message is a push transfer message.

12. The method of claim 1, wherein the receiver user device receives the digital tag associated with the sender from the sender user device.

13. A digital tag computer comprising:
a processor and
a computer readable medium comprising instructions executable by the processor to perform a method including:
receiving, from a receiver user device associated with receiver, a transfer request, wherein the transfer request comprises a digital tag associated with the receiver, a digital tag associated with a sender, and a transfer amount, wherein the digital tag associated with the receiver is linked to an account associated with the receiver and the digital tag associated with the sender is linked to an account associated with the sender;
generating a request identifier to be associated with the received transfer request;
transmitting, to a sender user device associated with the sender, the transfer request, wherein the transfer request further comprises the request identifier associated with the transfer request;
responsive to transmitting the transfer request, receiving, a transfer message relating to the transfer request; and
responsive to receiving the transfer message, transmitting the transfer message.

14. The digital tag computer of claim 13, wherein the digital tag computer is a server computer.

15. The digital tag computer of claim 13, further comprising a database storing a plurality of digital tags, and a plurality of locations of accounts linked to the digital tags.

16. The digital tag computer of claim 13, wherein the method further comprises:
receiving, by the digital tag computer, a request to resolve the digital tag associated with the receiver to an account number or token of the receiver.

17. The digital tag computer of claim 13, wherein the digital tags are in the form of machine readable QR codes.

18. A method comprising:
generating, by a receiver user device, a transfer request message comprising a digital tag associated with a receiver, a digital tag associated with the sender, and a transfer amount, wherein the digital tag associated with the receiver is linked to an account associated with the receiver and the digital tag associated with the sender is linked to an account associated with the sender;
transmitting, by the receiver user device to a digital tag computer, the transfer request message; and
receiving, by the receiver user device or an first transfer application server from the digital tag computer, a transfer message comprising the transfer amount, wherein the transfer message was generated by a sender user device, wherein the account of the receiver is credited with the transfer amount.

19. The method of claim 18, wherein the receiver user device is a mobile phone.

20. The method of claim 18, wherein the transfer message is an OCT message.
